(19) United States
(12) Patent Application Publication
(10) Pub. No.: US 2026/0107182 A1
(43) Pub. Date: Apr. 16, 2026

(54) MAPPING STREAM CLASSIFICATION SERVICE FLOWS TO TRAFFIC IDENTIFIERS FOR TRANSMISSION

(71) Applicant: Cisco Technology, Inc., San Jose, CA (US)

(72) Inventors: Binita Gupta, San Diego, CA (US); Malcolm M. Smith, Richardson, TX (US); Brian D. Hart, Sunnyvale, CA (US)

(21) Appl. No.: 19/274,125

(22) Filed: Jul. 18, 2025

Related U.S. Application Data
(60) Provisional application No. 63/706,907, filed on Oct. 14, 2024.

(51) Int. Cl. H04W 28/02; H04W 76/11; H04W 84/12

(52) U.S. Cl. CPC H04W 28/0268; H04W 76/11; H04W 84/12

(57) ABSTRACT

Methods for mapping Stream Classification Service (SCS) flows to Traffic Identifiers (TIDs)/Traffic Stream Identifiers (TSIDs) based on User Priority (UP) and quality of service (QoS) characteristics of SCS flows such that two SCS flows with the same UP but different QoS characteristics map to different TIDs/TSIDs to avoid head of line blocking. Methods involve obtaining, by a first wireless device, a first stream classification service (SCS) traffic flow and determining a user priority value and quality of service (QoS) characteristics of the first SCS traffic flow. The methods further involve mapping the first SCS traffic flow to a traffic identifier selected from a plurality of traffic identifiers based on a combination of the user priority value and the QoS characteristics and processing the first SCS traffic flow based on the traffic identifier for transmission to a second wireless device or when received from the second wireless device.

### CROSS-REFERENCE TO RELATED APPLICATION

This application claims the benefit of priority under 35 U.S.C. § 119(e) to U.S. Provisional Patent Application No. 63/706,907, filed on Oct. 14, 2024, which is hereby incorporated by reference in its entirety.

### TECHNICAL FIELD

The present disclosure relates to network equipment and network communications.

### BACKGROUND

Networking architectures have grown increasingly complex in communications environments, particularly wireless networking environments. The Wi-Fi Alliance (WFA) defines a Stream Classification Service (SCS), which allows a wireless device (also referred to as a “wireless station” or “STA”) to request downlink and uplink resources from an access point (AP) to meet quality of service (QoS) for a specific traffic flow. The SCS enables the wireless device to request the AP to apply specific QoS treatment of a downlink data flow and an uplink data flow using classifiers. For wireless local area networks, Institute of Electrical and Electronics Engineers (IEEE) 802.11 specifications includes Differentiated Service Code Point (DSCP) to User Priority (UP) mapping. The traffic flows are mapped to a (UP)/traffic identifier (TID) based on a DSCP-to-UP mapping. When multiple flows are mapped to the same TID, head-of-line (HOL) blocking issues may occur.

### BRIEF DESCRIPTION OF THE DRAWINGS

FIG. 1 is a diagram of an environment in which wireless devices negotiate mapping of SCS traffic flows to traffic identifiers based on User Priority (UP) and Quality of Service (QoS) characteristics, according to an example embodiment.

FIG. 2 is a diagram illustrating functional components of a first wireless device that process Stream Classification Service (SCS) traffic flows for transmission to a second wireless device, according to an example embodiment.

FIGS. 3A and 3B are diagrams illustrating a management frame that includes information for mapping SCS traffic flows to Traffic Identifiers (TIDs) based on UP and QoS characteristics, according to example embodiments.

FIG. 4 is a sequence diagram depicting a method of negotiating the number of Traffic Identifier/Traffic Stream Identifier (TID/TSID) values and rules for mapping certain SCS traffic flows to the TID/TSID values, according to an example embodiment.

FIG. 5 is a flowchart illustrating a method in which a first wireless device maps a first SCS flow to a traffic identifier based on a combination of UP and QoS characteristics of the SCS flow, according to an example embodiment.

FIG. 6 illustrates a hardware block diagram of a computing device that may perform functions associated with any combination of operations in connection with the techniques depicted and described in FIGS. 1, 2, 3A, 3B, 4, and 5, according to various example embodiments.

### DETAILED DESCRIPTION

### Overview

Briefly, techniques presented herein define rules for mapping Stream Classification Service (SCS) flows to Traffic Identifiers (TIDs) / Traffic Stream Identifiers (TSIDs) based on User Priority (UP) and quality of service (QoS) characteristics of SCS flows such that two SCS flows with the same UP but different QoS characteristics map to different TIDs/TSIDs to avoid head-of-line blocking.

In one form, methods involve obtaining, by a first wireless device, a first stream classification service (SCS) traffic flow and determining a user priority value and quality of service (QoS) characteristics of the first SCS traffic flow. The methods further involve mapping the first SCS traffic flow to a traffic identifier selected from a plurality of traffic identifiers based on a combination of the user priority value and the QoS characteristics and processing the first SCS traffic flow based on the traffic identifier for transmission to a second wireless device or when received from the second wireless device.

### EXAMPLE EMBODIMENTS

In a wireless local area network (WLAN) or Wi-Fi® network, one or more wireless access points (APs) provide wireless Radio Frequency (RF) coverage over which one or more wireless devices (e.g., phones, wearable devices, tablets, etc.) can connect to the APs in order to connect to one or more data networks (e.g., the public Internet, an enterprise network operated by an enterprise entity (e.g., a business, institution, university, etc.)), and/or the like. The wireless devices transmit and receive Internet Protocol (IP) data streams from the AP, which include time-sensitive data such as voice or video data and best-efforts data such as emails, file transfers, texts, etc.

Institute of Electrical and Electronics Engineers (IEEE) 802.11be introduces using a Stream Classification Service (SCS) to differentiate latency sensitive data streams from other data. The SCS prioritizes specific types of traffic flow to ensure that latency-sensitive applications receive low latency even in crowded network environments. This is accomplished in part by classifying a traffic flow based on a User Priority (UP) layer 2 field and mapping the UP to a Differentiated Services Code Point (DSCP) layer 3 field. Additionally, traffic flows are mapped to UP/TID based on a DSCP-to-UP mapping.

The terms TID and TSID, used interchangeably throughout the disclosure, are traffic identifiers useable by higher layer entities to distinguish medium access control (MAC) Service Data Units (MSDU) to MAC entities that support QoS within a MAC data service. As defined in various versions of the IEEE 802.11 protocol, TID/TSID is a label or a tag to classify data packets/streams according to the type of service. In a WLAN, packets can be a stream of video, voice, or data, which have different priorities when being serviced by the AP. The TIDs have defined values of 0-7 that correspond to UPs of 0-7. Additional proposed values for specific traffic streams are called Traffic Stream Identifiers (TSIDs) and have defined values of 8-15.

Default Request for Comments (RFC) 8325 defines DSCP-to-UP mapping that may be used or the AP may provide a network or deployment specific DSCP-to-UP mapping to user devices through a use of QoS map feature defined in IEEE 802.11 and Wi-Fi Alliance (WFA). The DSCP-to-UP mapping may result in multiple flows being mapped to the same UP/TID if these traffic flows are marked with the same DSCP value. As an example, an extended reality (XR) video flow and a video streaming flow may both be mapped to VI (Video) UP/TID 5. Some examples of XR video flows may be Augmented Reality (AR)/Virtual Reality (VR)/Mixed Reality (MR) data flows.

When multiple traffic flows are mapped to the same TID, traffic from these traffic flows are handled in the same TID queue. As such, traffic from one flow can lead to head-of-line (HOL) blocking for traffic from another flow that is mapped to the same TID, at a transmitter and/or at a receiver. At the transmitter, HOL blocking may occur if TID-based queuing is performed as packets arrive from different flows, and are mapped to the same TID without considering QoS characteristics for these traffic flows. At the receiver, if there is a hole in the receive reorder buffer for the TID, any packets received after that cannot be forwarded up to the stack. Consequently, this hole causes HOL blocking issue for forwarding these packets because packets are forwarded in order. HOL blocking becomes a concern for meeting desired QoS for traffic flows when traffic flows with different QoS characteristics i.e., different delay bound characteristics (e.g., XR flow and video streaming flow) are mapped to the same TID. In addition to the HOL blocking, mapping behavior described above may cause unnecessary delays and dropping of non-SCS traffic flows (during congestion) because too many resources are effectively allocated.

To solve the HOL blocking issue, there are efforts being discussed to increase the number of TIDs that map to a high priority Access Category (AC) such as a video stream flow (access category: video “AC_VI”) or a voice stream flow (access category: voice “AC_VO”). With more TIDs (e.g., TSID values 8-15), data flows mays be carried on different TIDs/TSIDs to avoid HOL blocking. If the number of TIDs/TSIDs is being increased, mechanisms should be defined on how to map SCS flows to these additional TSIDs (e.g., from 8-15) to take advantage of these new TSIDs. A DSCP-to-UP mapping involves mapping traffic flows to UP values from 0 to 7, that maps to TIDs 0 to 7. As such, the DSCP-to-UP mapping cannot be used for mapping to additional TID/TSID values.

Moreover, if multiple traffic flows are mapped to the same TID, this may also lead to scheduling inefficiency at the AP. The wireless device or wireless station may request QoS characteristics (QC) across multiple flows that map to the same TID with a smallest service interval (SI). For example, the wireless device may request quality of service (QoS) characteristics for TID 5 with 5 milliseconds (ms) SI (LCD interval of 5 ms to 35 ms) when two flows map to TID 6 such as an XR flow with 10 ms delay and a video flow with 35 ms delay. This leads to excess triggering and resource unit (RU) allocation for uplink flows, which is an inefficient resource utilization. For downlink flows, when multiple SCS flows with different QCs are mapped to the same TID (e.g. an XR flow with 10 ms delay and another video flow with 50 ms delay being mapped to the same TID 5), these flows are collectively prioritized more aggressively for delay and/or throughput requirements, which may lead to unfair preempting of other non-SCS traffic flows that map to the same AC (AC_VI). Hence, to avoid such inefficiency in the AP uplink and downlink scheduling, the techniques presented herein map flows to distinct TIDs/TSIDs values.

Techniques presented herein involve various mechanisms for mapping SCS flows to TIDs/TSIDs. In one example embodiment, the SCS traffic flows may be mapped to a new set of TSID values (e.g., from 8-15). A flow (identified by a TCLAS/IP tuple) is mapped to a UP, using the DSCP-to-UP mapping and then the flow is mapped from UP-to-TID and then to AC. The techniques presented herein enhance this mapping procedure with various mechanisms in which SCS traffic flows are mapped to distinct TIDs/TSIDs values. The techniques presented herein involve mechanisms in which mapping multiple flows to the same TID is avoided and/or minimized. The techniques presented herein support mapping SCS traffic flows to distinct existing TIDs (e.g., TID 0 and 1) and/or to new TSIDs (e.g., TSIDs 8 to 15) based on a unique combination of UP and QoS characteristics.

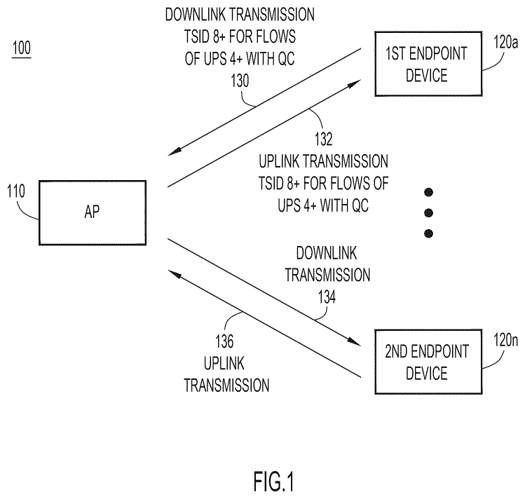

Referring now to FIG. 1, FIG. 1 is a diagram of an environment 100 in which wireless devices negotiate mapping of SCS traffic flows to traffic identifiers based on UP and QoS characteristics, according to an example embodiment. The environment 100 includes an AP 110 and endpoint devices 120a-n such as a first endpoint device 120a (client station) and a second endpoint device 120n.

The notations 1, 2, 3, . . . n; a, b, c, . . . n; “a-n”, “a-d”, “a-f”, “a-g”, “a-k”, “a-c”, and the like illustrate that the number of elements can vary depending on a particular implementation and is not limited to the number of elements being depicted or described. Moreover, this is only examples of various components, and the number and types of components, functions, etc. may vary based on a particular deployment and use case scenario.

This is only an example of the environment 100, and the number and types of entities may vary based on a particular deployment and use case scenario, such as the type of service being provided and network structures. For example, while the environment 100 includes the AP 110, other network devices may be present in the environment 100.

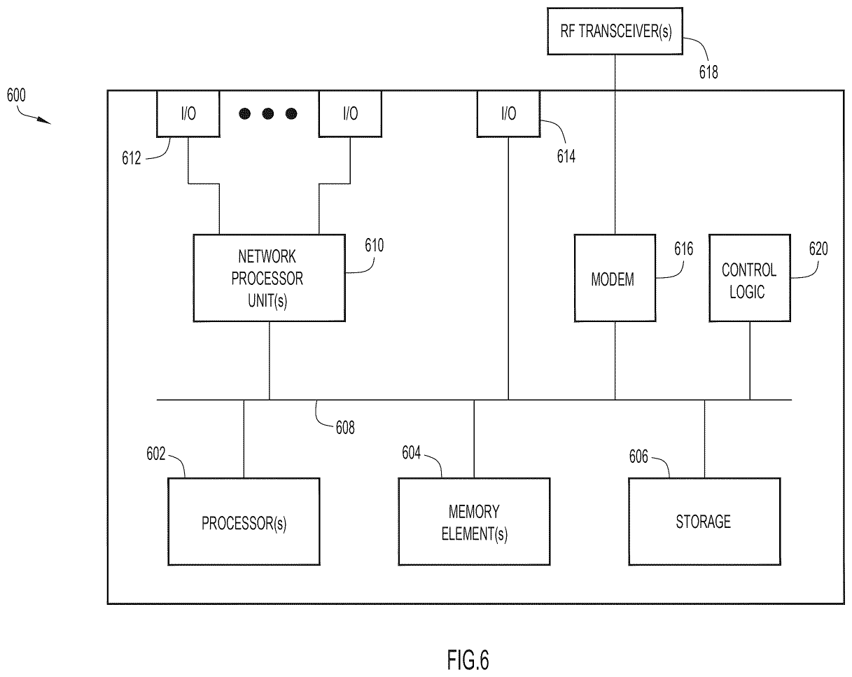

In various example embodiments, the entities in the environment 100 (the AP 110 and endpoint devices 120a-n) may each include a network interface, at least one processor, and a memory. Each entity may be an apparatus or any programmable electronic device capable of executing computer readable program instructions. The network interface may include one or more network interface cards (having one or more ports) that enable components of the entity to send and receive packets or data over the network(s), such as a local area network (LAN) or a wide area network (WAN), and/or wireless access networks. Each entity may include internal and external hardware components such as those depicted and described in further detail in FIG. 6. In one example, at least some of these entities may be embodied as virtual devices with functionality distributed over a number of hardware devices, such as virtual APs, switches, routers, servers, etc.

The AP 110 may be a WLAN AP configured with appropriate hardware (e.g., processor(s), memory element(s), antennas and/or antenna arrays, baseband processors (modems), and/or the like), software, logic, and/or the like to provide Over-the-Air (OTA) coverage for a WLAN access network (e.g., Wi-Fi®). In various example embodiments, the AP 110 may be implemented as Wi-Fi access point (AP) and/or the like. The AP 110 may be configured with appropriate hardware (e.g., processor(s), memory element(s), antennas and/or antenna arrays, baseband processors (modems), and/or the like), software, logic, and/or the like to facilitate respective OTA interfaces for accessing/connecting to the endpoint devices 120a-n (to send and receive packets). The AP 110 may be managed or controlled by wireless LAN controller (WLC), not shown.

The endpoint devices 120a-n are depicted as the first endpoint device 120a and the second endpoint device 120n. Each endpoint device is a client station or any suitable device configured to initiate a flow in the environment 100, such as data source device and/or data sink device. For example, the endpoint device may include a computer, an enterprise device, an appliance, an Internet of Things (IoT) device, a Personal Digital Assistant (PDA), a laptop or electronic notebook, a smartphone, a tablet, and/or any other device and/or combination of devices, components, elements, and/or objects capable of initiating voice, audio, video, media, or data exchanges within the environment 100. The endpoint device may also include any suitable interface to a human user such as a microphone, a display, a keyboard, or other terminal equipment. The endpoint device may be configured with appropriate hardware (e.g., processor(s), memory element(s), antennas and/or antenna arrays, baseband processors (modems), and/or the like such as those depicted and described in further detail in FIG. 6), software, logic, and/or the like to facilitate respective OTA interfaces for accessing/connecting to the AP 110 and sending or receiving packets including various traffic flows.

Each of the endpoint devices 120a-n is configured to connect a user to a public network. The endpoint device is connected to (establishes an association with) the AP 110. The AP 110 and the endpoint devices 120a-n may represent a wireless infrastructure that provides Wireless Local Area Network (WLAN) coverage for a specific geographic area/location. For example, wireless infrastructure may serve an airport, a shopping mall, a train station, a venue, etc. The AP 110 and the endpoint devices 120a-n may use various wireless access network protocols, such as the Wi-Fi® wireless technology, to send and receive various packets. In one example, the endpoint devices 120a-n may be configured to connect to a WLAN (e.g., through the AP 110), and initially, may be part of a Wi-Fi® network offered in a corporate, enterprise, or dorm room environment. The AP 110 and the endpoint devices 120a-n are wireless devices that communicate in a WLAN network.

In the environment 100, the AP 110 may advertise, to the plurality of endpoint devices 120a-n, its support for additional TSID values or its support for using TIDs (e.g., access category: best effort “AC_BE” and/or access category: background “BK”) to avoid HOL blocking issues. The first endpoint device 120a supports use of additional TSID values and as such, may negotiate the number of additional TSIDs and rules for use e.g., TSID 8+ for UPs 7+ with QoS characteristics (QC). As an example, based on these negotiations, the first endpoint device 120a performs downlink transmission using TSIDs 8+ for SCS traffic flows having UPs 4+ and corresponding QC, shown at 130, and performs uplink transmission using TSIDs 8+for traffic flows of UP 4+ with the corresponding QC, shown at 132.

On the other hand, the second endpoint device 120n does not support additional TSIDs and may continue communicating using TIDs (values 0 to 7). That is, no additional TSIDs are allocated for use to this second endpoint device 120n for the downlink transmission from the AP 110 (downloading/streaming data), shown at 134 and for the uplink transmission to the AP 110, shown at 136.

Traffic flows that are identified by a TCLAS/IP tuple are mapped to UPs, using the DSCP-to-UP mapping. The traffic flows are further mapped from UP to TID/TSID according to various techniques presented herein and are then mapped from the TID/TSID to a respective AC.

### Exemplary Techniques for Mapping SCS Traffic Flows to TIDs/TSIDs

In one or more example embodiments, a first wireless device obtains a first stream classification service (SCS) traffic flow and determines a user priority value (UP) and quality of service (QoS) characteristics (QC) of the first SCS traffic flow. The first wireless device then maps the first SCS traffic flow to a traffic identifier (TID/TSID) selected from a plurality of traffic identifiers based on a combination of the UP and the QC. The first wireless device then processes the first SCS traffic flow based on the traffic identifier for transmission to a second wireless device or when received from the second wireless device. In other words, the first wireless device maps the first SCS traffic flow to a traffic identifier queue selected from multiple TID/TSID queues based on a combination of the user priority value and quality of service characteristics (QC).

QoS characteristics are defined as a measure of performance for a transmission system that reflects its transmission quality and service availability. The QoS characteristics include parameters such as latency, jitter, and loss. The QC element is defined in IEEE 802.11be and may include fields such as an element identifier, a length, an element identifier extension, control information, minimum service interval, maximum service interval, minimum data rate, etc. The control information field includes direction, TID, user priority (UP), etc.

### 1. Mapping SCS Flows to TSIDs

SCS traffic flows are mapped to new TSIDs values 8 to 15 (and TIDs values 0 to 7) based on a unique combination of an associated UP value and QoS characteristics (QC). Two SCS traffic flows (identified by different TCLAS values) that map to the same UP (based on a DSCP-to-UP mapping) but have different QoS characteristics are mapped to different TSID values. Each unique combination of UP and QC is mapped to a different TSID value. This enables flows with same UP and different QoS characteristics to map to different TSIDs. Hence, these active SCS flows can be prioritized separately. As such, any head-of-line blocking issue among these SCS traffic flows is avoided.

In one example embodiment, a first wireless device applies a unique mapping from UP and QC to TSID only for high priority UPs (e.g., VO UPs 7 and 6 and VI UPs 5 and 4). As such, SCS traffic flows that map to same UP and have same/similar QC are mapped to the same TSID, and these SCS traffic flows thus receive similar QoS treatment. Since these SCS traffic flows have similar QoS, these SCS traffic flows are prioritized equally for transmission. Accordingly, HOL blocking issue is minimized.

In another example embodiment, only SCS traffic flows that map to high priority UPs and also have associated QC map to TSID values (values 8 to 15). Other SCS traffic flows that map to high priority UPs (UP values 7, 6, 5 and 4) but do not have an associated QC are mapped to their corresponding TIDs (TID values 7, 6, 5 and 4) and high priority flows with QC do not map to these TID values (values 4-7).

In yet another example embodiment, SCS traffic flows that map to high priority UPs and do not have QC defined can also be mapped to TSID values (values 8 to 15), to avoid HoL blocking issues among these SCS traffic flows. In this case, every new active SCS traffic flow for a UP is mapped to a new TSID, and when all of the allowed TSIDs are exhausted, then new SCS traffic flows are mapped to one of the already used TSIDs/TIDs.

In one or more example embodiments, each TSID value has either one mapped SCS traffic flow or if multiple SCS traffic flows are mapped, then these SCS traffic flows have the same UP. The UP of the SCS traffic flow(s) that are mapped to a TSID value is preserved and is used to determine the mapped AC for this TSID. As such, a (UP, TSID) tuple is mapped to the AC, which corresponds to the UP using the UP/TID to AC mapping. For example, a SCS traffic flow with UP5 and QC maps to TSID 8 and then TSID 8 maps to AC_VI (AC corresponding to UP5 or TID5).

In one or more example embodiments, a set of additional TSID values (for example n values) such as a minimum of 1 TSID and maximum of 8 TSIDs are defined for mapping flows with high priority UPs. These additional TSIDs are shared across high priority UPs and are used dynamically when mapping flows based on a combination of UP and QC to TSID for any of the high priority UPs. In this scheme, there is no rigid mapping of TSID to high priority UPs (and corresponding ACs). A set of available TSIDs is sharable among the active SCS traffic flows and may be dynamically mapped to VO UPs (and hence to AC_VO) or VI UPs (and hence to AC_VI) based on a current set of active SCS traffic flows. This may be a preferred mapping mechanism because the flexibility of mapping to the additional TSID values enhances utilization of the additional TSIDs space across high priority UPs. High priority UPs are UP values above a predetermined priority value e.g., UP 4. The predetermined priority value may also be adjusted depending on a particular use case scenario. Once a TSID is mapped to a UP category (VO or VI), it is not available for use by other high priority UP categories (and corresponding AC).

As an example, data flows that map to VO UPs (UP 7 and 6) are assigned TSID values starting from the highest allowed TSID value, and data flows that map to VI UPs (UP 5 and 4) are assigned TSID values starting from the lowest allowed TSID value. As such, if TSID values 8-11 are allowed, then a flow that maps to UP 6 is assigned TSID 11, and another flow that maps to UP 5 is assigned TSID 8. In this flexible mapping technique, higher TSID values are assigned to flows with VO UPs (if any) and lower TSID values are assigned to flows with VI UPs (if any).

As another example, some TSID values are defined for use only by SCS traffic flows of VI UPs (TSID 8 and 9), and other TSID values are defined for use only by flows of VO UPs (TSID 10 and 11). This mapping technique provides a more rigid partition of TSID space and may be appropriate in some instances depending on a usage policy for TSIDs applied by the AP 110. In short, mapping mechanisms may vary depending on a particular deployment and use case scenario.

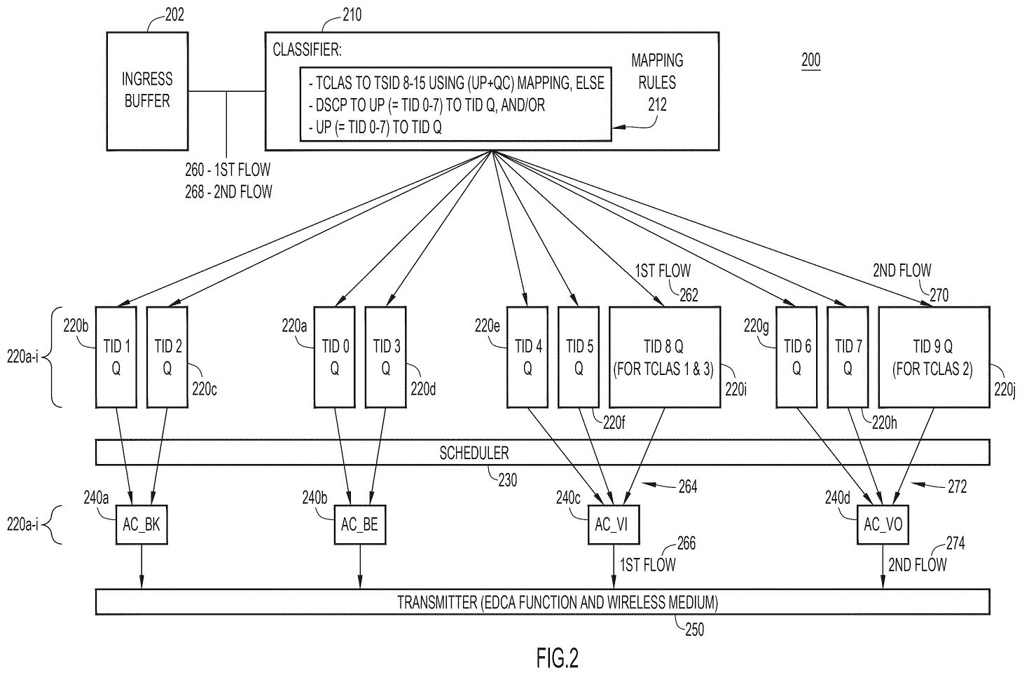

With continued reference to FIG. 1, FIG. 2 is a diagram illustrating functional components 200 of a first wireless device that processes SCS traffic flows for transmission to a second wireless device, according to an example embodiment. The first and second wireless devices may be the AP 110 and one of the endpoint devices 120a-n of FIG. 1. The functional components 200 include an ingress buffer 202, a classifier 210 that has mapping rules 212, a plurality of TID queues 220a-j for storing active SCS traffic flows, a scheduler 230 that schedules the SCS traffic flows for transmission by storing the SCS traffic flows in one of AC queues 240a-d, and a transmitter 250. The functional components 200 may be implemented by a combination of hardware and software, such as shown in FIG. 6.

The ingress buffer 202 is configured to store incoming data such as SCS traffic flows or data flows that include a plurality of data packets. The traffic flows may be generated by the first wireless device or received from other wireless device(s).

The classifier 210 is configured to determine a TID queue from the plurality of TID queues 220a-j for the incoming SCS traffic flows based on a combination of the user priority (UP) value and the QC. The classifier 210 determines the proper TID queue based on the mapping rules 212 previously negotiated between the first wireless device and the second wireless device (e.g., the AP 110 and one of the endpoint devices 120a-n). For example, the classifier 210 may be instructed to map TCLAS to TSID queues 8-15 using UP value and QC and otherwise, the classifier 210 may be instructed to use DSCP to IP mapping for TID queues 0-7 and/or UP is mapped to TID 0-7 and their corresponding queues from the TID queues 220a-j.

The TID queues 220a-j are storage queues or buffers that store categorized or classified data packets (traffic flows) based on the type of service. The TID queues 220a-j are each assigned to a respective user priority value (and some to an associated QC) depending on the mapping rules 212.

For example, TID queues 220a-j include a first TID queue 220a (TID 0 queue) assigned to UP 0, a second TID queue 220b (TID 1 queue) assigned to UP 1, a third TID queue 220c (TID 2 queue) assigned to UP 2, a fourth TID queue 220d (TID 3 queue) assigned to UP 3, a fifth TID queue 220e (TID 4 queue) assigned to the UP 4, a sixth TID queue 220f (TID 5 queue) assigned to the UP 5, a seventh TID queue 220g (TID 6 queue) assigned to UP 6, an eighth TID queue 220h (TID 7 queue) and two TSID queues. The two TSID queues are a ninth TID queue 220i (TID 8 queue) and tenth TID queue 220j (TID 9 queue). Each of these two TSID queues is assigned to particular traffic classification(s) (TCLAS) and QC i.e., high UP with an associated QC. As an example, the ninth TID queue 220i is assigned to TCLAS 1 and TCLAS 3 with QCs 1 and 3, whereas the tenth TID queue 220j is assigned to TCLAS 2 with QC2. The QCs 1 and 3 are substantially different from QC2.

In this example, the TID queues 10-15 are not shown because they do not exist. In other words, in the negotiations between the two wireless devices, TID queues 10-15 are not resourced. As noted above, the number of TID queues being resources may depend on a particular deployment and use case scenario and the disclosure is not limited to a particular number of resourced TID queues.

The scheduler 230 may deploy an Enhanced Distributed Channel Access (EDCA) mechanism that supports differentiated and distributed access to a wireless medium based on traffic priority and access category. The scheduler 230 retrieves packets of the active SCS traffic flows from the TID queues 220a-i and maps these packets/data streams to one of the AC queues 240a-d for sharing access to the wireless medium of the transmitter 250. In one example embodiment, the scheduler 230 determines the transmission priority for each SCS traffic flow by mapping a tuple of the UP value and the TID/TSID to a respective AC selected from a plurality of access categories of an enhanced distributed channel access (EDCA) mechanism. For example, determining the transmission priority may include giving a higher transmission priority to an SCS flow that has more stringent QoS characteristics requirement over another SCS flow that maps to the same access category. The scheduler 230 schedules traffic flows for transmission by moving data packets into a selected one of the AC queues 240a-d.

The AC queues 240a-d are memory queues or buffers that hold data streams according to their application or service type. As an example, the scheduler 230 moves data packets from the second TID queue 220b and the third TID queue 220c to a first AC queue 240a (background access category “AC_BK”). The scheduler 230 moves data packets of the SCS traffic from the first TID queue 220a and the fourth TID queue 220d to a second AC queue 240b (best effort access category “AC_BE”). Additionally, the scheduler 230 moves data packets from the fifth TID queue 220e, the sixth TID queue 220f, and the ninth TID queue 220i to a third AC queue 240c (video access category “AC_VI”) and from the seventh TID queue 220g, the eighth TID queue 220h, and tenth TID queue 220j to a fourth AC queue 240d (audio access category “AC_VO”). The scheduler 230 uses a tuple of the UP value and the TID/TSID to map the data packets to the respective AC queue. As noted above, the SCS traffic flows that have more stringent QoS characteristics but may have the same access category may be assigned a higher transmission priority.

The transmitter 250 includes an EDCA function to transmit data over the wireless medium. The EDCA function prioritizes traffic based on its access category (AC). The transmitter 250 uses contention based access in which a channel is held for a predetermined time interval to enable transmission of multiple frames consecutively from a particular AC queue from among the access queues 240a-d i.e., an enhanced distributed channel access. In short, each access category contends for a channel for its own use, and the access category with the higher priority (e.g., the third AC queue 240c (AC_VI) and the fourth AC queue 240d (AC_VO)) wins the contention and transmits multiple frames within a predetermined time interval e.g., a contention window.

In one or more example embodiments, the first wireless device may process incoming data streams for transmission to the second wireless device as follows.

At 260, data from the ingress buffer 202 is obtained by the classifier 210. For example, a first traffic flow is obtained and is defined as TCLAS 1 traffic with QC 1. The classifier 210 assigns the first traffic flow to the ninth TID queue 220i because TCLAS 1 is a high UP traffic flow and has associated QC. As such, at 262, the first traffic flow is stored in the ninth TID queue 220i (for TCLAS 1 and 3 with associated QC 1). The scheduler 230 then classifies the first traffic flow to the third AC queue 240c. At 264, the first traffic flow is stored in the third AC queue 240c. At 266, the first traffic flow is prioritized and provided for transmission to the transmitter 250.

At 268, a second traffic flow having TCLAS 2 and QC 2 is retrieved from the ingress buffer 202. The QC2 is very different from the QC1. As such, the classifier 210 classifies the second traffic flow into a different TID queue. For example, at 270, the second traffic flow is stored in the tenth TID queue 220j based on the mapping rules 212. The second traffic flow is assigned to a different TID queue because the QC is substantially different from the QC of the first traffic flow. At 272, the second traffic flow is then stored in the fourth AC queue 240d (AC_VO). When the fourth AC queue 240d wins the contention, at 274, the second traffic flow is provided to the transmitter 250 for transmission.

The subsequent traffic flows are processed/mapped accordingly, based on the mapping rules 212. For example, a third traffic flow having TCLAS 3, QC3 may also be stored in the ingress buffer 202. The QC3 is similar to QC1 but different from the QC2. The third traffic flow may then also be assigned to the ninth TID queue 220i and prioritizes for transmission.

In other words, a wireless device maps an SCS traffic flow (identified by a TCLAS) based on a combination of its respective UP and QoS characteristics to a TSID (or TID) based on an allowed set of TSIDs for the UP category (VI or VO). If two flows that map to same UP and have the same or very similar QoS characteristics, then these two flows are mapped to the same TSID/TID (e.g., the first traffic flow and the third traffic flow). If two traffic flows that map to the same UP and have different QCs, then these two traffic flows are mapped to a different TSID/TID provided an unused TSID/TID value or queue is available. When no unused (or unallocated) TSID/TID queues exist for a respective UP category, then any new traffic flow that maps to this UP value is then mapped to an already mapped TSID/TID value for this UP that has traffic flow/flows with closest matching QC as the new traffic flow.

As another example, the mapping rules 212 may define that high priority traffic flows with QC map to both a TID value and a TSID value. The classifier 210 of the wireless device then starts by mapping to an existing TID for the high priority UP. For example, the classifier 210 maps a first SCS traffic flow with UP5 and QC to the sixth TID queue 220f (TID5) and maps a second SCS traffic flow with UP4 and QC to the fifth TID queue 220e (TID 4). Then, a third traffic flow that is mapped to UP5/UP4 (VI UP) but has a different QC is mapped to the ninth TID queue 220i (TSID 8). Next, any subsequent traffic flow that maps to UP5/UP4 and has a different QC is mapped to tenth TID queue 220j (TSID 9). In this example, the traffic flow(s) from the tenth TID queue 220j would be provided to the third AC queue 240c (AC_VI).

Similarly for VO UPs, the classifier 210 of the wireless device starts by mapping to an existing TID for VO UPs. For example, the classifier 210 maps a first traffic flow with UP7 and QC to the eighth TID queue 220h (TID7) and maps a second traffic flow with UP6 and QC to the seventh TID queue 220g (TID 6). Then, any subsequent traffic flow that is mapped to UP7/UP6 and has a different QC is now mapped to TSID 10. Next, any traffic flow that maps to UP7/UP6 and has a different QC is mapped to TSID 11.

As yet another example, the mapping rules 212 define that TID values 4-7 are used only by SCS traffic flows that do not have an associated QC and that traffic flows with QC are mapped only to TSID values. The mapping rules 212 further define that a pool of TSID values are available across all traffic flows with high UPs. In this case, the classifier 210 of the wireless devices maps any traffic flow that has a high priority UP (UP values 7, 6, 5 or 4) but does not have any associated QC to the corresponding TID value (TID queues 220e-h). For example, a first traffic flow having UP7 but without QC is mapped to the eighth TID queue 220h (TID 7), a second traffic flow with UP6 without QC is mapped to the seventh TID queue 220g (TID 6), a third traffic flow with UP5 but without QC is mapped to the sixth TID queue 220f (TID 5), and a fourth traffic flow having UP4 but also without QC is mapped to the fifth TID queue 220e (TID 4). On the other hand, traffic flows that have a high priority UPs and have an associated QC are mapped to TSID values. For example, a fifth traffic flow that is mapped to any of the UP7/UP6/UP5/UP4 and has an associated QC is now mapped to the ninth TID queue 220i (TSID 8). A sixth traffic flow that is mapped to any of the UP7/UP6/UP5/UP4 and has a different QC is now mapped to tenth TID queue 220j (TSID 9), etc.

In yet another example, the mapping rules 212 may define that traffic flows with high priority UPs and associated QC are mapped to a different TID/TSID regardless of the similarities among the QC. The mapping rules 212 may further define that when all of the available or allowed TIDs/TSIDs values are allocated to the existing active traffic flows, then some of these traffic flows are remapped based on a similarity of the QC. This mapping mechanism may be beneficial because it avoids mapping multiple flows to same TSID/TID initially as long as there are unused TSIDs, reducing HOL blocking issues even among flows that have same or similar QC.

In yet another example, the mapping rules 212 may define that only SCS traffic flows that have user priority values higher than a predetermined priority value regardless of the QC are to be mapped to one of the plurality of traffic identifiers based on the combination of the user priority value and the QoS characteristics.

In one example embodiment, the TSID values (8 to 15) may also be applied for mapping traffic flows with other UPs (e.g., best effort flows with UP 0 or 3), and not only restricted to high priority UPs of 4, 5, 6, or 7 (AC_VI and AC_VO UPs). Accordingly, the mapping rules described above may also be used for flows of other UP values.

### 2. Mapping SCS Flows to TIDs

In IEEE 802.11bn, an additional mapped TID approach may be adopted, which allows mapping of the traffic flows to a TID selected from AC_BE or AC_BK category. This is to avoid HOL blocking issue by not mapping multiple flows to the same TID. That is, TID values from a best effort access category and/or a background access category are repurposed for mapping a plurality of SCS flows having a video user priority or a voice user priority.

The AP 110 and one of the endpoint devices 120a-n may use the mapping mechanism defined above (using a combination of (UP, QC)) to determine to map traffic flows to a different TID from AC_BK (TID 1 or 2) or AC_BE (TID 0 or 3) category (instead of TSIDs from 8 to 15). That is, while example embodiments described above illustrate mapping of traffic flows to the TSIDs, in at least one example embodiment, no additional TID values are deployed and the traffic flows are mapped to the existing TID values (TID 0-8). That is, some of the existing TID values are repurposed for video user priority and voice user priority. As such, two different traffic flows that map to the same UP/TID (e.g., TID 5) are now mapped to different existing TIDs (TID values 0-8). For example, a first SCS traffic flow is mapped to the TID 5 and a second SCS traffic flow is mapped to the TID 3 based on having different QCs values such that the first traffic flow has a delay bound of 10 msec and the second traffic flow has a delay bound for 50 msec.

In one example embodiment, the SCS traffic flows that have specific QoS characteristics are eligible to use the additional traffic identifiers (TIDs). For example, only SCS traffic flows that are set to latency or delay bound of 10 msec or lower or flows that require data rate higher than certain minimum data rate value are eligible to use the additional TIDs e.g., TID values from a background access category (repurposed for these SCS traffic flows). This may be indicated as an additional field in a policy for usage of the TIDs. The existing TIDs are repurposed for specific QoS characteristics. In one example, the SCS traffic flows that have more stringent QoS characteristics but the same access category may be assigned a higher transmission priority.

In one or more example embodiments, the mapping rules 212 define a mechanism for mapping traffic flows to various TIDs/TSIDs based on a combination of UP and QC. The TIDs/TSIDs may be sharable and/or may be used by UPs regardless of QCs. For example, an access point may provide to a wireless endpoint device, a policy for usage of the plurality of traffic identifiers (TSIDs explained above or repurposed TIDs). The policy may include one or more of the following fields. A first field may indicate whether an additional traffic identifiers feature is enabled on the access point. A second field may indicate the number of the plurality of traffic identifiers supported by the access point. The policy may further include a bitmap indicating allowed set of plurality of traffic identifiers supported by the access point. The third field may indicate which user priority values are eligible to use the plurality of traffic identifiers and a fourth field may indicate whether only SCS flows that have specific QoS characteristics are eligible to use the plurality of traffic identifiers. The policy for usage of the plurality of traffic identifiers may further include one or more mapping rules indicating whether the plurality of traffic identifiers are sharable among a plurality of SCS traffic flows having allowed user priority values and the QoS characteristics or whether each of the plurality of traffic identifiers is assigned a respective user priority value and the QoS characteristics. The mapping rules may further indicate whether some or all of the plurality of traffic identifiers are allowed to be used for low latency, low loss, scalable throughput (L4S) traffic flows.

### Scheduling Wireless Frames Mapped to Different TIDs/TSIDs

Generally, the wireless device prioritizes scheduling of traffic belonging to a higher priority TID, e.g., TID 5 traffic is prioritized higher than TID 4. With the use of additional TSID values according to one or more example embodiments, the TSIDs may be assigned dynamically to VO UPs and VI UPs and TSID values may not be in strict sequence numbering order for priority. For example, TSIDs 8 and 9 may be assigned to VO UP and then, TSIDs 10 and 11 may be assigned to VI UP, where TSIDs of VO access category are prioritized over TSIDs of VI access category.

As such, in one or more example embodiments, the scheduler 230 of the wireless device prioritizes among scheduling of wireless frames (Media Access Control Protocol Data Units “MPDUs”) belonging to different mapped TSIDs for the same UP (or AC) based on QC of associated flow(s) for each such TSID. The scheduler 230 assigns a higher priority to TSIDs with more stringent QCs. An internal scheduling priority is assigned among TSIDs that map to the same AC, based on QC of the mapped traffic flow(s) and perhaps other scheduling policies. Then, the scheduling priority is used to prioritize transmission of the wireless frames (MPDUs) across the TSIDs that map to the same AC. In one example embodiment, dynamic and more fine-grained scheduling is deployed, such as prioritizing wireless frame(s) of a TID having an upcoming delay bound.

As an example, the scheduler 230 may prioritize the ninth TID queue 220i that stores UPs with QC over the fifth TID queue 220e and the sixth TID queue 220f. As another example, the scheduler 230 may prioritize the first traffic flow and the third traffic flow with QC1 over the second traffic flow with QC2, when QC1 has stricter QoS characteristics (less jitter, lower latency, lower packet loss allowed, etc.)

In one example embodiment, when traffic flows that are mapped to the same UP (e.g., based on a DSCP-to-UP mapping) are mapped to different TIDs by using one or more additional mapped TIDs from AC_BK or AC_BE, the scheduler 230 is configured to identify and prioritize these traffic flows.

Specifically, the scheduler 230 performs EDCA channel access for the buffered traffic flow based on the access category determined from the UP of the traffic flow, and not based on the additional mapped TID. In other words, the scheduler 230 determines the UP and QC of the traffic flows for the EDCA channel access without considering (regardless of) the TID value of the respective flow.

For example, if the first flow maps to UP/TID 5 (maps to AC_VI) but the traffic flow is queued into the second TID queue 220b (TID 1 “AC_BK”) when no additional TSID queues are deployed and/or when additional TSID queues are occupied. The scheduler 230 performs EDCA channel access for this traffic flow based on AC_VI contention parameters (regardless of the TID value). This mechanism ensures that the scheduler 230 handles traffic flows based on the right AC for channel access. Moreover, traffic flows that map to the same UP/TID (e.g., TID 5) but are mapped to different TIDs (e.g., TID 5 and TID 1) are scheduled based on their QC parameters. Traffic flows with more stringent QC parameters are prioritized even if these flows map to a TID from AC_BK or AC_BE.

### Advertising TID/TSID Mappings

Currently, only TID values from 0 to 7 are used for traffic flows. Even in Ultra-High Reliability (UHR) Wi-Fi® or IEEE 802.11bn, some wireless devices may not support additional TSIDs due to impact on queuing and scheduling. As shown in FIG. 1, only a subset of wireless devices may support use of TSIDs. As such, use of TSID values (from 8 to 15 values or a subset of these values) are to be negotiated between the AP 110 and the endpoint devices 120a-n. For example, the AP 110 may advertise its support for using additional TSID values in a management frame such as beacon frames, probe response frames, association response frames, and/or a reassociation response frames e.g., in a UHR capabilities element or another element.

With continued reference to FIGS. 1 and 2, FIGS. 3A and 3B illustrate a management frame 300, 350, respectively, that includes information for mapping SCS traffic flows to TIDs based on UP and QC, according to example embodiments. The management frame 300 or 350 may be a beacon broadcasted by the AP 110 of FIG. 1 to various endpoints devices 120a-n in its geographic proximity, a probe response provided in response to a probe request transmitted by a respective endpoint device, and/or an association or reassociation response frame.

To advertise support for use of additional TSID values (TSIDs) or support for using existing TID values for traffic flows with high UP, the beacon and/or probe response may include additional elements or elements indicative of whether additional traffic identifiers are enabled on the AP 110, the number of additional or available supported traffic identifiers, a bitmap for UP values and QCs that are eligible to use the additional TIDs/TSIDs, and various mapping rules. Examples of such mapping rules may include whether the TIDs/TSIDs are sharable among the SCS traffic flows that have allowed user priority values and the QoS characteristics, or whether each TID/TSID is assigned a respective UP and QC., etc.

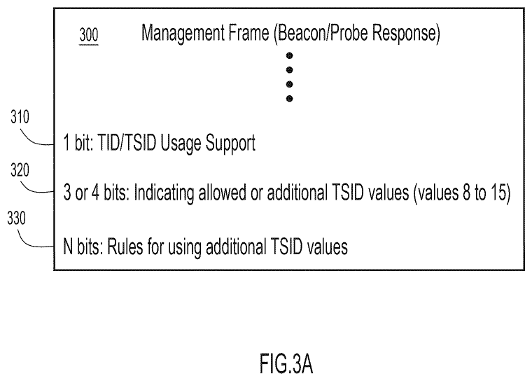

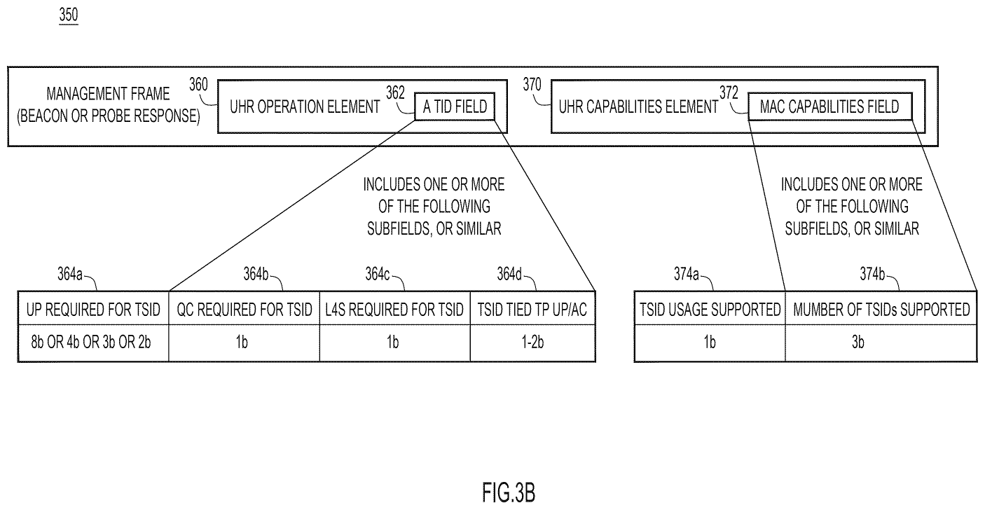

For example, the management frame 300 in FIG. 3A (e.g., the beacon and/or probe response and/or association response and/or reassociation response) includes a first field 310 that indicates whether TSID usage is supported, a second field 320 that indicates a number of allowed or additional TSID values (allowed TSIDs), and mapping rules 330.

The first field 310 may be a one bit value that indicates whether an additional TSID usage support feature is enabled. The first field 310 may be specify whether an additional mapping mechanism for existing TID values is supported by the AP 110. For example, the first field 310 may be a one bit value with 0 indicating that additional TSIDs are not supported and 1 indicating that additional TSIDs are supported.

The second field 320 may be a three or four bits value. The second field 320 indicates the number of additional or allowed TSID values e.g., 8-15 values. For example, the allowed TSID values includes a 4-bit field, which is set to the highest allowed TSID value (e.g., “1111” value is equal to 0-15 TSID values). As another example, the second field 320 may be a 3-bit field where value 0 indicates that TIDs 0-8 (includes TSID 8) are allowed, value 1 indicates TIDs 0-9 (includes TSIDs 8 and 9), and so on, with value 7 indicating TIDs 0-15 (includes TSID 8-15) are allowed.

Alternatively, instead of the second field 320, a bitmap of 8 bits may be used. In this bitmap, each bit indicates an allowed value from a range of 8 to 15.

The mapping rules 330 are rules for using additional TSID values. The mapping rules 330 may vary in length and may be n bits long. For example, the mapping rules 330 may include one or more of:
(a) indicate UPs of the SCS flows that are eligible to use additional TSIDs,
(b) indicate whether additional TSIDs are to be used only for flows with QoS characteristics (only flows with QC are eligible to use the additional TSIDs),
(c) indicate whether additional TSIDs are sharable among allowed UPs (flexible approach) or whether certain TSIDs are used only for certain UPs (rigid approach), and
(d) indicate whether low latency, low loss, and scalable throughput flows (L4S) flows are eligible to use the additional TSID values, and whether some or all of the available additional TSIDs values are to be used for these L4S flows.

As another example, the management frame 350 in FIG. 3B (e.g., the beacon and/or probe response and/or association response and/or reassociation response) includes TSID related information in one or more UHR fields. Specifically, the management frame 350 includes a UHR operation element 360 with a TID field 362 and a UHR capabilities element 370 with media access control (MAC) capabilities field 372.

The TID field 362 includes one or more of the following subfields: a first subfield 364a that defines UP required for TSID, a second subfield 364b that defines QC required for TSID, a third subfield 364c for L4S flows required for TSID, and a fourth subfield 364d for defining TSID tied to UP/AC.

The first subfield 364a may be of different sizes depending on a particular deployment and use case scenario. For example, the first subfield 364a may be 8 bits, 4 bits, 3 bits, or 2 bits. The first subfield 364a may be a bitmap indicating which UPs (8b) or QoS UPs, i.e., UPs 4-7 (4b) are eligible to use TSIDs.

The second subfield 364b and the third subfield 364c may be one bit elements. In the second subfield 364b, 0 indicates that stream classification service (SCS) quality of service characteristics agreement is not required for a flow to use TSIDs and 1 indicates that SCS quality of service characteristics agreement is required for a flow to use TSIDs. In the third subfield 364c, 0 indicates that L4S agreement is not required for a flow to use TSIDs and 1 indicates that L4S agreement is required for a flow to use TSIDs.

The fourth subfield 364d indicates whether TSID is tied to UP/AC and may be a one bit value or two bits value. In the fourth subfield 364d, 0 may indicate that TSIDs are sharable among all allowed UPs/ACs, 1 may indicate that certain TSIDs are to be used only for certain UPs. Mapping rules may be defined separately (a mapping of UP to TSID in a bitmap) where 1 TSID for 1 UP or 2 TSIDs per UP 4-7, etc. Additionally, in the fourth subfield 364d, 2 may indicate that certain TSIDs can be used only for certain ACs. This may be omitted if only one bit is allocated to the fourth subfield 364d. Mapping rules may be defined separately (a mapping of TSID to AC) where 1 TSID for one UP value or 2 TSIDs per UP 4-7, etc. In the fourth subfield 364d, 3 may indicate a reserved bit when the size of the fourth subfield 364d is 2 bits.

The MAC capabilities field 372 may include one or more of the following subfields: a first subfield 374a that indicates TSID usage supported and a second subfield 374b that indicates number of TSIDs supported. The first subfield 374a may be a one bit value that indicates whether the AP 110 is enabled for additional TSIDs or for new mapping rules for the TIDs (similar to the first field 310 of FIG. 3A). The second subfield 374b indicates the number of TSIDs supported (similar to the second field 320 of FIG. 3A). As an example, in the second subfield 374b, 0 indicates TIDs 0-8, 1 indicates TIDs 0-9, . . . , and 7 indicates TIDs 0-15.

Using the management frame 300 or 350, the AP 110 is configured to provide its support for TID/TSID usage and mapping rules. However, these management frames are just examples of conveying TID/TSID mapping mechanisms. The disclosure is not limited thereto and particular fields and/or frame formats may depend on a particular deployment and use case scenario.

Negotiating TID/TSID Usage between Wireless Devices

In addition to the AP 110 providing its support for using TSIDs and its mapping rules, the endpoint devices 120a-n may also have restrictions and/or constraints for using TSIDs. The endpoint devices 120a-n may have limited capability for TSID support and may support fewer number or values of TSIDs than the AP 110. For example, the first endpoint device 120a may only support four additional TSID values while the AP 110 advertises eight additional TSID values. As such, the AP 110 and the first endpoint device 120a may negotiate the number of additional TSID values and the mapping rules.

With continued reference to FIGS. 1, 2, 3A, and 3B, FIG. 4 is a sequence diagram illustrating a method 400 of negotiating the number of TID/TSID values and rules for mapping certain SCS traffic flows to the TID/TSID values, according to an example embodiment. The method 400 involves two wireless devices such as the AP 110 and the first endpoint device 120a.

Specifically, the method 400 involves at 402, obtaining, by the first endpoint device 120a from the AP 110, a beacon and/or a probe response indicating support of additional TSIDs (or new uses for existing TIDs) such as the management frame 300, 350 of FIG. 3A or 3B. As such, the first endpoint device 120a learns the AP's capability for additional TSID usage based on the beacon and/or probe response and/or reassociation response, and/or some other management frame.

The method 400 further involves at 404, providing, by the first endpoint device 120a to the AP 110, a (Re)association request. In the (Re)association request, the first endpoint device 120a indicates its own TSID usage capability e.g., in the UHR capabilities element 370 of FIG. 3B or in another element. For example, the first endpoint device 120a indicates the number of additional TSIDs that are supported or allowed by the first endpoint device 120a.

The method 400 further involves at 406, the AP 110 matching additional TSIDs capabilities of the first endpoint device 120a and with its own resources and at 408, providing, to the first endpoint device 120a, a (Re)association response. In the (Re)association response, the AP 110 indicates the additional TSIDs that the first endpoint device 120a is allowed to use along with rules for TSID use (mapping rules). For example, if the AP 110 supports TSIDs 8-15 and the first endpoint device 120a only supports TSID 8-11, the AP 110 can indicate in the (Re)association response that it supports use of TSID 8-11 for the first endpoint device 120a and state that these additional TSIDs may be shared dynamically across SCS traffic flows with VO or VI UPs.

Both the first endpoint device 120a and the AP 110 would then use TSIDs from 8-11 for transmission and reception of the SCS traffic flows. As shown at 410, the transmission (Tx) and reception (Rx) traffic flows use additional TSIDs based on mapping rules.

In some cases, the AP 110 may allow a lower number of additional TSIDs than what is supported by the first endpoint device 120a due to resource constraints at the AP 110, at the (Re)association time. That is, at 412, the AP 110 detects a change in available resources. Based on the detected change, the method 400 further involves at 414, providing, to the first endpoint device 120a, a management frame such as a SCS response, indicating a new number of additional TSIDs to be used and new mapping rules for using the additional TSIDs. That is, the AP 110 dynamically changes TSID use for the first endpoint device 120a through a protected management frame (e.g., using an unsolicited SCS Response) to allow more or less TSIDs (within the supported limit by the first endpoint device 120a) as conditions change. As such, at 416, the AP 110 and the first endpoint device 120a use new additional TSIDs based on new mapping rules for transmitting and receiving SCS traffic flows.

In an alternative example embodiment, the AP 110 may simply advertise TSID values being used in the Basic Service Set (BSS) in the UHR operation element 360 of FIG. 3B or another element in a beacon/probe response along with mapping rules for usage of TSIDs. The first endpoint device 120a is expected to support announced TSID values if it associates with the AP 110 (e.g., a multi-link device “MLD AP”) and uses TSID values based on the mapping rules announced by the AP 110.

In one example embodiment, the SCS request, from the first endpoint device 120a to the AP 110 (not shown), may include in the QC element, the TSID and UP for the corresponding SCS traffic flow. If the mapped TSID value does not align with the negotiated TSID values and mapping rules and/or announced TSID values and mapping rules, then the AP 110 rejects the SCS request with an appropriate reason code (e.g., REJECT_TSID_USAGE_NOT_PER_POLICY). In other words, the AP 110 may control the number of TSIDs and the mapping rules for TSIDs.

The techniques presented herein support use of TSIDs in IEEE 802.11bn to avoid head-of-line blocking and scheduling inefficiencies. The techniques presented herein define rules for mapping SCS traffic flows to TIDs/TSIDs based on a unique combination of UP and/or QoS characteristics of the SCS traffic flows. Additionally, the techniques provide a mechanism for advertising TID/TSID use and mapping rules, and for negotiating use and mapping rules between first and second wireless devices within the BSS. Further, the techniques provide a mechanism for dynamically changing number of allowed TIDs/TSIDs and mapping rules based on network conditions.

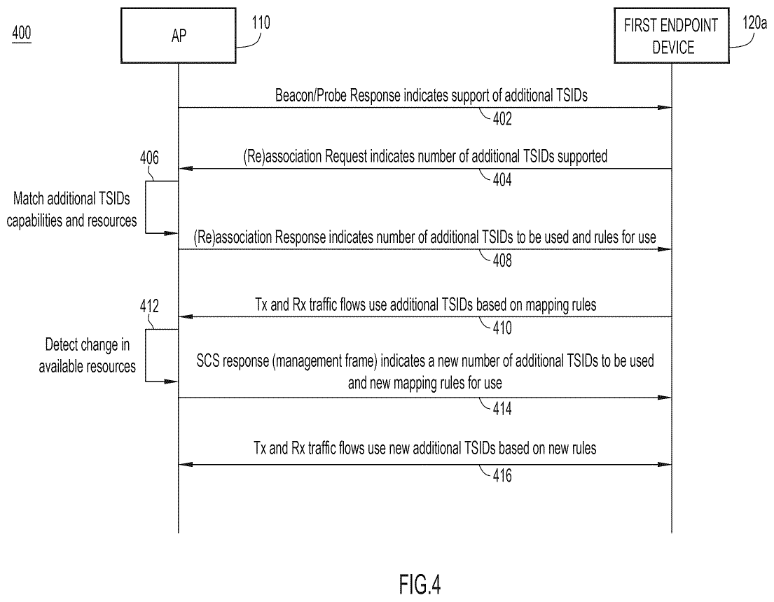

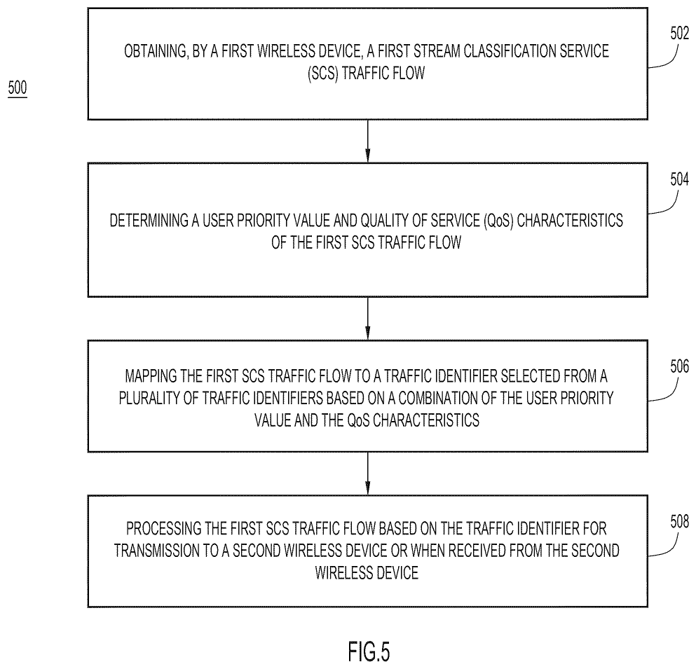

FIG. 5 is a flowchart illustrating a method 500 in which a first wireless device maps a first SCS flow to a traffic identifier based on a combination of UP and QoS characteristics of the SCS flow, according to an example embodiment. The method 500 may be performed by the AP 110 or one of the endpoint devices 120a-n of FIG. 1 or FIG. 4, the functional components 200 of the first wireless device of FIG. 2, or a computing device (an apparatus) of FIG. 6.

The method 500 involves at 502, obtaining a first stream classification service (SCS) traffic flow and at 504, determining a user priority value and quality of service (QoS) characteristics of the first SCS traffic flow.

The method 500 further involves at 506, mapping the first SCS traffic flow to a traffic identifier selected from a plurality of traffic identifiers based on a combination of the user priority value and the QoS characteristics.

The method 500 further involves at 508, processing the first SCS traffic flow based on the traffic identifier for transmission to a second wireless device or when received from the second wireless device.

In one form, the method 500 may further involve mapping a second SCS traffic flow with the user priority value of the first SCS traffic flow and different QoS characteristics than those of the first SCS traffic flow to a different traffic identifier of the plurality of traffic identifiers.

In one instance, the plurality of traffic identifiers may be traffic identifier values from 0 to 7 of a wireless local area network and may be configured to map to access categories for a plurality of SCS traffic flows.

In another instance, the plurality of traffic identifiers may be traffic identifier (TID) values from at least one of a best effort access category or a background access category that are repurposed for mapping a plurality of SCS flows having a video user priority or a voice user priority.

In yet another instance, the plurality of traffic identifiers may be additional traffic identifier values from 8 to 15 of a wireless local area network and are configured to map to access categories for SCS traffic flows.

In yet another instance, the plurality of traffic identifiers may map to at least one of a video stream access category or a voice stream access category.

According to one or more example embodiments, the method 500 may further involve communicating, with the second wireless device, to negotiate a number of the plurality of traffic identifiers, which are supported by the first wireless device, and to negotiate one or more mapping rules for the plurality of traffic identifiers.

In one instance, the method 500 may further involve communicating, with the second wireless device, to negotiate a different number of the plurality of traffic identifiers based on a change of resources available to the first wireless device and/or the second wireless device.

In another instance, the first wireless device and the second wireless device may be a wireless station and an access point, respectively. The plurality of traffic identifiers may be traffic identifiers (TIDs) of a Wi-Fi® network or traffic stream identifiers (TSIDs) of the Wi-Fi® network.

According to one or more example embodiments, in the method 500, communicating to negotiate the number of the plurality of traffic identifiers and the one or more mapping rules may involve providing, by the access point to the wireless station, a policy for usage of the plurality of traffic identifiers that includes one or more of: a first field indicating that an additional traffic identifiers feature is enabled on the access point, a second field indicating the number of the plurality of traffic identifiers supported by the access point, a bitmap indicating an allowed set of the plurality of traffic identifiers supported by the access point, a third field indicating which of a plurality of user priority values are eligible to use the plurality of traffic identifiers, a fourth field indicating whether only a set of SCS flows that have specific QoS characteristics are eligible to use the plurality of traffic identifiers, the one or more mapping rules indicating whether the plurality of traffic identifiers are sharable among a plurality of SCS traffic flows having allowed user priority values and the QoS characteristics or whether each of the plurality of traffic identifiers is assigned a respective user priority value and the QoS characteristics, and one or more mapping rules indicating whether one or more of the plurality of traffic identifiers are allowed to be used for low latency, low loss, scalable throughput (L4S) traffic flows.

In one instance, the policy for usage of a plurality of traffic identifiers may be provided by the access point in a beacon, a probe response, an association response, a reassociation response, or another management frame.

In one form, the one or more mapping rules may define that only SCS traffic flows that have user priority values higher than a predetermined priority value and associated QoS characteristics are to be mapped to one of the plurality of traffic identifiers based on the combination of the user priority value and the QoS characteristics.

In another form, the one or more mapping rules may define that only SCS traffic flows that have user priority values higher than a predetermined priority value regardless of the QoS characteristics are to be mapped to one of the plurality of traffic identifiers based on the combination of the user priority value and the QoS characteristics.

In yet another form, the one or more mapping rules may define that every new SCS traffic flow with the user priority value higher than a predetermined priority value and associated QoS characteristics is to be mapped to a different traffic identifier from the plurality of traffic identifiers until each of the plurality of traffic identifiers has an assigned SCS traffic.

According to one or more example embodiments, the method 500 may further involve determining a transmission priority of the first SCS traffic flow by mapping a tuple of the user priority value, the QoS characteristics, and the traffic identifier to a respective access category from a plurality of access categories of an enhanced distributed channel access (EDCA) mechanism. The plurality of access categories may include a video access category (AC_VI) and a voice access category (AC_VO).

In one form, the operation of determining the transmission priority may include assigning a higher transmission priority to the first SCS flow that has more stringent QoS characteristics requirement than a second SCS flow that maps to the same access category.

In another form, the method 500 may further include determining an enhanced distributed channel access (EDCA) access category for the first SCS flow that is mapped to a first traffic identifier of the plurality of traffic identifiers in a best effort access category (AC_BE) or a background access category (AC_BK) based on the user priority of the first SCS flow and not based on the first traffic identifier of the first SCS flow.

According to one or more example embodiments, the traffic identifier assigned to the first SCS traffic flow may not be available for use by other active SCS flows.

FIG. 6 illustrates a hardware block diagram of a computing device 600 that may perform functions associated with any combination of operations in connection with the techniques depicted and described in FIGS. 1, 2, 3A, 3B, 4, and 5, according to various example embodiments, including, but not limited to, operations of the AP 110, one of the endpoint devices 120a-n of FIG. 1 or 4, or the first wireless device of FIG. 2. It should be appreciated that FIG. 6 provides only an illustration of one example embodiment and does not imply any limitations with regard to the environments in which different embodiments may be implemented. Many modifications to the depicted environment may be made.

In at least one embodiment, the computing device 600 may be any apparatus that may include one or more processor(s) 602, one or more memory element(s) 604, storage 606, a bus 608, one or more network processor unit(s) 610 interconnected with one or more network input/output (I/O) interface(s) 612, one or more I/O interface(s) 614, a baseband processor or a modem 616, radio RF transceiver(s) 618, and control logic 620. In various embodiments, instructions associated with logic for computing device 600 can overlap in any manner and are not limited to the specific allocation of instructions and/or operations described herein.

Computing device 600 may further include at least one baseband processor or modem 616, one or more radio RF transceiver(s) 618 (e.g., any combination of RF receiver(s) and RF transmitter(s)), one or more antenna(s) or antenna array(s) (which may be inclusive of software-defined antenna(s) or antenna array(s) in accordance with example embodiments herein.

In at least one embodiment, processor(s) 602 is/are at least one hardware processor configured to execute various tasks, operations and/or functions for computing device 600 as described herein according to software and/or instructions configured for computing device 600. Processor(s) 602 (e.g., a hardware processor) can execute any type of instructions associated with data to achieve the operations detailed herein. In one example, processor(s) 602 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 604 and/or storage 606 is/are configured to store data, information, software, and/or instructions associated with computing device 600, and/or logic configured for memory element(s) 604 and/or storage 606. For example, any logic described herein (e.g., control logic 620) can, in various embodiments, be stored for computing device 600 using any combination of memory element(s) 604 and/or storage 606. Note that in some embodiments, storage 606 can be consolidated with memory element(s) 604 (or vice versa) or can overlap/exist in any other suitable manner.

In at least one embodiment, bus 608 can be configured as an interface that enables one or more elements of computing device 600 to communicate in order to exchange information and/or data. Bus 608 can be implemented with any architecture designed for passing control, data and/or information between processors, memory elements/storage, peripheral devices, and/or any other hardware and/or software components that may be configured for computing device 600. In at least one embodiment, bus 608 may be implemented as a fast kernel-hosted interconnect, potentially using shared memory between processes (e.g., logic), which can enable efficient communication paths between the processes.

In various embodiments, network processor unit(s) 610 may enable communication between computing device 600 and other systems, entities, etc., via network I/O interface(s) 612 (wired and/or wireless) to facilitate operations discussed for various embodiments described herein. In various embodiments, network processor unit(s) 610 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 600 and other systems, entities, etc. to facilitate operations for various embodiments described herein. In various embodiments, network I/O interface(s) 612 can be configured as one or more Ethernet port(s), Fibre Channel ports, any other I/O port(s), and/or antenna(s)/antenna array(s) now known or hereafter developed. Thus, the network processor unit(s) 610 and/or network I/O interface(s) 612 may include suitable interfaces for receiving, transmitting, and/or otherwise communicating data and/or information (wired and/or wirelessly) in a network environment.

I/O interface(s) 614 allow for input and output of data and/or information with other entities that may be connected to computing device 600. For example, I/O interface(s) 614 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

The RF transceiver(s) 618 may perform RF transmission and RF reception of wireless signals via antenna(s)/antenna array(s), and the baseband processor or modem 616 performs baseband modulation and demodulation, etc. associated with such signals to enable wireless communications for computing device 600.

In various embodiments, control logic 620 can include instructions that, when executed, cause processor(s) 602 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

In another example embodiment, an apparatus is provided. The apparatus includes a memory, a network interface configured to communicate in a network, and a processor coupled to the network interface. The processor is configured to perform operations that include obtaining a first stream classification service (SCS) traffic flow and determining a user priority value and quality of service (QoS) characteristics of the first SCS traffic flow. The operations further include mapping the first SCS traffic flow to a traffic identifier selected from a plurality of traffic identifiers based on a combination of the user priority value and the QoS characteristics and processing the first SCS traffic flow based on the traffic identifier for transmission to a wireless device or when received from the wireless device.

In yet another example embodiment, one or more non-transitory computer readable storage media encoded with instructions are provided. When the media is executed by a processor, the instructions cause the processor to execute a method that includes obtaining a first stream classification service (SCS) traffic flow and determining a user priority value and quality of service (QoS) characteristics of the first SCS traffic flow. The method further includes mapping the first SCS traffic flow to a traffic identifier selected from a plurality of traffic identifiers based on a combination of the user priority value and the QoS characteristics and processing the first SCS traffic flow based on the traffic identifier for transmission to a second wireless device or when received from the second wireless device.

In yet another example embodiment, a system is provided that includes the devices and operations explained above with reference to FIGS. 1, 2, 3A, 3B, and 4-6.

The programs described herein (e.g., control logic 620) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 604 and/or storage 606 can store data, software, code, instructions (e.g., processor instructions), logic, parameters, combinations thereof, and/or the like used for operations described herein. This includes memory element(s) 604 and/or storage 606 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®/Wi-Fi7®), IEEE 802.16 (e.g., Worldwide Interoperability for Microwave Access (WiMAX)), Radio-Frequency Identification (RFID), Near Field Communication (NFC), Bluetooth™, mm. wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and, in the claims, can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, service, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
obtaining, by a first wireless device, a first stream classification service (SCS) traffic flow;
determining a user priority value and quality of service (QoS) characteristics of the first SCS traffic flow;
mapping the first SCS traffic flow to a traffic identifier selected from a plurality of traffic identifiers based on a combination of the user priority value and the QoS characteristics; and
processing the first SCS traffic flow based on the traffic identifier for transmission to a second wireless device or when received from the second wireless device.

2. The method of claim 1, further comprising:
mapping a second SCS traffic flow with the user priority value of the first SCS traffic flow and different QoS characteristics than those of the first SCS traffic flow to a different traffic identifier of the plurality of traffic identifiers.

3. The method of claim 1, wherein the plurality of traffic identifiers are traffic identifier values from 0 to 7 of a wireless local area network and are configured to map to access categories for a plurality of SCS traffic flows.

4. The method of claim 1, wherein the plurality of traffic identifiers are traffic identifier (TID) values from at least one of a best effort access category or a background access category that are repurposed for mapping a plurality of SCS flows having a video user priority or a voice user priority.

5. The method of claim 1, wherein the plurality of traffic identifiers are additional traffic identifier values from 8 to 15 of a wireless local area network and are configured to map to access categories for SCS traffic flows.

6. The method of claim 1, wherein the plurality of traffic identifiers map to at least one of a video stream access category or a voice stream access category.

7. The method of claim 1, further comprising:
communicating, by the first wireless device with the second wireless device, to negotiate a number of the plurality of traffic identifiers, which are supported by the first wireless device, and to negotiate one or more mapping rules for the plurality of traffic identifiers.

8. The method of claim 7, further comprising:
communicating, by the first wireless device with the second wireless device, to negotiate a different number of the plurality of traffic identifiers based on a change of resources available to the first wireless device and/or the second wireless device.

9. The method of claim 7, wherein the first wireless device and the second wireless device are a wireless endpoint device and an access point, respectively, and wherein the plurality of traffic identifiers are traffic identifiers (TIDs) of a Wi-Fi® network or traffic stream identifiers (TSIDs) of the Wi-Fi® network.

10. The method of claim 9, wherein communicating to negotiate the number of the plurality of traffic identifiers and the one or more mapping rules includes:
providing, by the access point to the wireless endpoint device, a policy for a usage of the plurality of traffic identifiers that includes one or more of:
a first field indicating that an additional traffic identifiers feature is enabled on the access point,
a second field indicating the number of the plurality of traffic identifiers supported by the access point,
a bitmap indicating an allowed set of the plurality of traffic identifiers supported by the access point,
a third field indicating which of a plurality of user priority values are eligible to use the plurality of traffic identifiers,
a fourth field indicating whether only a set of SCS flows that have specific QoS characteristics are eligible to use the plurality of traffic identifiers,
the one or more mapping rules indicating whether the plurality of traffic identifiers are sharable among a plurality of SCS traffic flows having allowed user priority values and the QoS characteristics or whether each of the plurality of traffic identifiers is assigned a respective user priority value and the QoS characteristics, and
the one or more mapping rules indicating whether one or more of the plurality of traffic identifiers are allowed to be used for low latency, low loss, scalable throughput (L4S) traffic flows.

11. The method of claim 10, wherein the policy for the usage of the plurality of traffic identifiers may be provided by the access point in a beacon, a probe response, an association response, a reassociation response, or another management frame.

12. The method of claim 7, wherein the one or more mapping rules define that only SCS traffic flows that have user priority values higher than a predetermined priority value and associated QoS characteristics are to be mapped to one of the plurality of traffic identifiers based on the combination of the user priority value and the QoS characteristics.

13. The method of claim 7, wherein the one or more mapping rules define that only SCS traffic flows that have user priority values higher than a predetermined priority value regardless of the QoS characteristics are to be mapped to one of the plurality of traffic identifiers based on the combination of the user priority value and the QoS characteristics.

14. The method of claim 7, wherein the one or more mapping rules define that every new SCS traffic flow with the user priority value higher than a predetermined priority value and associated QoS characteristics is to be mapped to a different traffic identifier from the plurality of traffic identifiers until each of the plurality of traffic identifiers has an assigned SCS traffic flow.

15. The method of claim 1, further comprising:
determining a transmission priority of the first SCS traffic flow by mapping a tuple of the user priority value, the QoS characteristics, and the traffic identifier to a respective access category from a plurality of access categories of an enhanced distributed channel access (EDCA) mechanism, wherein the plurality of access categories include a video access category (AC_VI) and a voice access category (AC_VO).

16. The method of claim 15, wherein determining the transmission priority comprises:
assigning a higher transmission priority to the first SCS flow that has a more stringent QoS characteristics than a second SCS flow that maps to same access category.

17. The method of claim 15, further comprising:
determining an enhanced distributed channel access (EDCA) access category for the first SCS flow that is mapped to a first traffic identifier of the plurality of traffic identifiers in a best effort access category (AC_BE) or a background access category (AC_BK) based on the user priority value of the first SCS flow and not based on the first traffic identifier of the first SCS flow.

18. The method of claim 1, wherein the traffic identifier assigned to the first SCS traffic flow is not available for use by other active SCS flows.

19. An apparatus comprising:
a memory;
a network interface configured to enable network communications; and
a processor, wherein the processor is configured to perform a method comprising:
obtaining a first stream classification service (SCS) traffic flow;
determining a user priority value and quality of service (QoS) characteristics of the first SCS traffic flow;
mapping the first SCS traffic flow to a traffic identifier selected from a plurality of traffic identifiers based on a combination of the user priority value and the QoS characteristics; and
processing the first SCS traffic flow based on the traffic identifier for transmission to a wireless device or when received from the wireless device.

20. The apparatus of claim 19, wherein the processor is further configured to perform:
mapping a second SCS traffic flow with the user priority value of the first SCS traffic flow and different QoS characteristics than those of the first SCS traffic flow to a different traffic identifier of the plurality of traffic identifiers.

21. The apparatus of claim 19, wherein the plurality of traffic identifiers are one or more of:
traffic identifier values from 0 to 7 of a wireless local area network and are configured to map to access categories for a plurality of SCS traffic flows, or
additional traffic identifier values from 8 to 15 of the wireless local area network and are configured to map to the access categories for the plurality of SCS traffic flows.

22. One or more non-transitory computer readable storage media encoded with software comprising computer executable instructions that, when executed by a processor, cause the processor to perform a method including:
obtaining a first stream classification service (SCS) traffic flow;
determining a user priority value and quality of service (QoS) characteristics of the first SCS traffic flow;
mapping the first SCS traffic flow to a traffic identifier selected from a plurality of traffic identifiers based on a combination of the user priority value and the QoS characteristics; and
processing the first SCS traffic flow based on the traffic identifier for transmission to a wireless device or when received from the wireless device.

23. The one or more non-transitory computer readable storage media according to claim 22, wherein the computer executable instructions cause the processor to further perform:
mapping a second SCS traffic flow with the user priority value of the first SCS traffic flow and different QoS characteristics than those of the first SCS traffic flow to a different traffic identifier of the plurality of traffic identifiers.

24. The one or more non-transitory computer readable storage media according to claim 22, wherein the plurality of traffic identifiers are one or more of:
traffic identifier values from 0 to 7 of a wireless local area network and are configured to map to access categories for a plurality of SCS traffic flows, or
additional traffic identifier values from 8 to 15 of the wireless local area network and are configured to map to the access categories for the plurality of SCS traffic flows.
